(19) United States
(12) Patent Application Publication
(10) Pub. No.: US 2012/0042715 A1
(43) Pub. Date: Feb. 23, 2012

(54) Advanced micro flow sensor

(75) Inventor: Chang Liu, Winnetka, IL (US)

(73) Assignee: Northwestern University

(21) Appl. No.: 12/930,695

(22) Filed: Jan. 13, 2011

Related U.S. Application Data
(60) Provisional application No. 61/335,951, filed on Jan. 14, 2010.

(51) Int. Cl. G01N 11/02; G01F 1/34; G01F 1/68; G01F 1/56

(52) U.S. Cl. 73/54.01; 73/861.08; 73/861.42; 73/204.11

(57) ABSTRACT

Multiple flow sensors in an array are provided to achieve wide dynamic range, low detection limit, and potentially low cost. Each flow sensor can measure the flow rate of surrounding fluid, among other fluid parameters. The flow sensor can be rendered active by inclusion of a piezoelectric element so as to be capable of achieving mechanical vibration, hence allowing it to interact with local fluid surroundings, or capable of converting mechanical energy in the surrounding fluid to electrical signals and energy.

This application claims benefits and priority of U.S. provisional application Ser. No. 61/335,951 filed Jan. 14, 2010, the disclosure of which is incorporated herein by reference.

### CONTRACTUAL ORIGIN OF THE INVENTION

This invention was made with government support under Grant No.: FA9550-05-1-0459 (UIUC) NU Subcontract: 2005-02899-08 awarded by AFOSR (Air Force Office of Scientific Research). The Government has certain rights in the invention.

### FIELD OF THE INVENTION

The invention relates to flow rate sensing, microflow sensors, and energy conversion.

### BACKGROUND OF THE INVENTION

Flow sensing has many important applications, including industry, transportation vehicles, and medicine. Flow sensors should ideally have the following desirable characteristics:
1. low detection limit;
2. wide dynamic range (defined as the ratio between the largest detectable input to the lowest);
3. durable and compatible with the fluid and applications;
4. repeatable and reliable;
5. low cost.

Over the years, flow sensor technologies have been developed by both academic researchers and industries. Micro electro mechanical systems (MEMS) flow sensors have been developed based on heat transfer principles, on thermal time of flight principles, and on momentum transfer principles. Some advanced flow sensors have attempted mimic flow sensors found on fish (lateral line) and spiders (leg hairs).

An artificial haircell microsensor (AHC) and a method of fabricating it on an SOI wafer are described by N. Chen et al. in “Design and Characterization of Artificial Haircell Sensor for Flow Sensing With Ultrahigh Velocity and Angular Sensitivity”, Vol. 16, No. 5, October 2007, and comprises a cylindrical, substantially rigid cilium made of SU-8 epoxy located at a distal end of a paddle-shaped silicon cantilever beam. Doped silicon piezoresistive strain gages are located at the base of the cantilever.

Applicant's U.S. Pat. Nos. 7,357,035 and 7,516,671 describe a sensor chip having a flexible polymer-based substrate and one or more micro-fabricated rectangular-cross section haircell sensors disposed vertically on the substrate together with one or more other sensors, such as a temperature sensor, thermal conductivity sensor, and contact force and hardness sensor.

### SUMMARY OF THE INVENTION

The present invention provides in one embodiment an array of a plurality of passive and/or active sensors each having an artificial cilium on a cantilever wherein the sensors are systematically configured and arranged relative to one another in the array to achieve both large dynamic range and low detection limit. In an illustrative embodiment, a one- or two-dimensional array of haircell sensors is provided wherein one or more sensor parameters systematically change from one sensor to the next in the array to achieve both large dynamic range and low detection limit. The sensor parameters can include the height (h) of the artificial cilium, the diameter (d) of the artificial cilium, the cantilever length (l), the cantilever width (w), the cantilever thickness (t) and/or relative cantilever orientations to this end.

An active flow sensor pursuant to the invention can include a piezoelectric element as an active actuator and/or active energy harvesting element in flow sensing applications. The piezoelectric element can convert electric potential (or field) to mechanical stress and displacement. Conversely, the piezoelectric element can turn mechanical stress and strain into charge accumulation and electric potential. As such, the sensor of this embodiment can perform a number of unique functions, including:
1) producing displacement and vibration upon applying an electric bias;
2) generating a signal proportional to the external stimuli input;
3) producing charge accumulation and energy accumulation (harvesting) upon mechanical input;
4) it is also possible to oscillate the haircell at a certain frequency, and then use the same piezoelectric element or other means to monitor the magnitude of the response. Since the response is a function of the viscosity of the fluid surrounding the hair, the viscosity of the fluid can be measured.

The piezoelectric element can be located on the cantilever or on the artificial cilium, or on any part of the sensor structure as long as favorable electrical-mechanical conversion can be achieved and the fabrication process is feasible.

Furthermore, it is possible to chemically functionalize parts of the sensor, such as the artificial cilium using chemically functional materials such that the sensor's mass will change upon binding with species in the fluid. As a result, the sensor will be made capable of chemical and biological sensing.

Embodiments of the invention can provide a multi-modal flow sensor that comprises one or more flow sensors each with an artificial cilium on a cantilever, one or more pressure sensors, one or more temperature sensors, etc. For example, using the same microfabrication process as used to fabricate the sensor with the cilium on the cantilever, it is possible to fabricate a sensor chip that also contains one or more diaphragm pressure sensors, hot film anemometers, hot wire anemometers, thermal-transfer based flow shear stress sensors, temperature sensors, and time-of-flight flow velocity sensors. These multi-modal sensors present a comprehensive view of the flow field of interest.

Advantages of the present invention will become more apparent from the following detailed description taken with the following drawings.

### BRIEF DESCRIPTION OF THE DRAWINGS

FIG. 1 is a schematic diagram of a haircell sensor.

FIG. 2 shows pertinent dimensions of the haircell sensor of FIG. 1.

FIG. 3 is a schematic diagram of a representative one-dimensional array of three haircell sensors where the length of the cantilevers L1, L2, and L3 is varied form one sensor to the next in the array.

FIG. 4 is a schematic diagram of a representative one-dimensional array of three haircell sensors where the height h1, h2, h3 is varied form one sensor to the next in the array.

FIG. 5 is a schematic diagram of a representative one-dimensional array of three haircell sensors where the diameter d1, d2, d3 of the artificial ciliums is varied form one sensor to the next in the array.

FIG. 6A is a photomicrograph of an array of three haircell sensors where the cantilever length is varied from one sensor to the next and the longitudinal axes of the cantilevers are parallel.

FIG. 6B is a photomicrograph of an array of three haircell sensors where the cantilever lengths are the same but the longitudinal axes of the cantilevers are at an angle to one another; e.g. perpendicular to one another.

FIG. 7 is a schematic diagram showing that arrayed sensors with varying parameters such as l, w, t, h, d, can cover a much broader range of desired performance characteristics (e.g. flow rate, frequency response, etc.) than a single sensor.

FIG. 8 is a schematic diagram showing that arrayed haricell sensors with varying cantilever lengths from one sensor to the next pursuant to the invention can cover a much broader range of desired performance characteristics (e.g. flow rate, frequency response, etc.) than a single haricell sensor with cantilever length L. In the array, the cantilever length decreases from sensor 5 to sensor 4, from sensor 4 to sensor 1, from sensor 1 to sensor 2, and sensor 2 to sensor 3 to this end.

FIG. 9 illustrates an active haricell sensor pursuant to the invention incorporating a piezoelectric material element on the cantilever. The piezoelectric element can be disposed on the artificial cilium in lieu or in addition to being disposed on the cantilever.

FIG. 10 is a photomicrograph of a representative multi-modal sensor chip containing haircell flow sensors, pressure sensors, and thermal sensors.

FIG. 11 is a scanning electron micrograph (SEM) of a section of the sensor chip of FIG. 10 showing three haircell sensors with varying cantilever lengths from one haircell sensor to the next, a thermal sensor, and a pressure sensor.

FIG. 12 is an enlarged view of the three haircell sensors of FIG. 11 better showing the decreasing cantilever lengths from one sensor to the next in the SEM.

FIG. 13 is a SEM of two neighboring haircell sensors that are positioned at an angle to one another; e.g. the longitudinal axes of the cantilevers are perpendicular to one another.

FIG. 14 is a SEM of a thermal isolated sensor on the sensor chip of FIG. 11 wherein the sensor can measure temperature of the fluid or the thermal shear stress of the fluid boundary layer.

FIG. 15 is a SEM of a membrane pressure sensor on the sensor chip of FIG. 11.

FIG. 16a through 16h illustrates a microfabrication process for making a passive haircell sensor with a piezoresistive element.

FIG. 17 illustrates a hair cell sensor having both a piezoresistive element and a piezoelectric element.

### DETAILED DESCRIPTION OF THE INVENTION

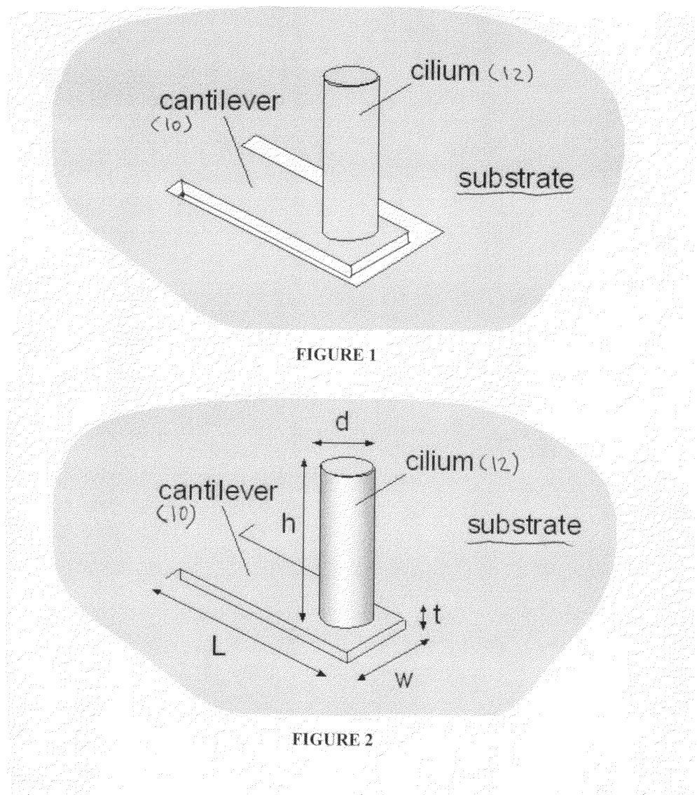

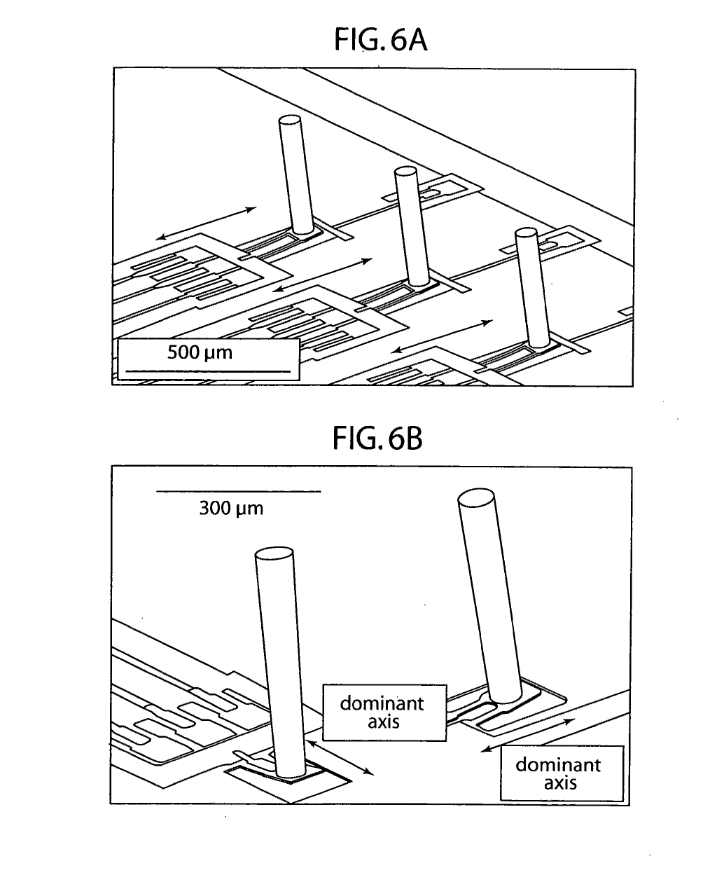

In one illustrative embodiment of the present invention, an array of a plurality of passive and/or active artificial haircell (ACH) sensors is provided wherein the sensors are systematically configured and arranged relative to one another in the array to achieve both large dynamic range and low detection limit. For purposes of illustration, FIGS. 1-2 show an individual haircell sensor, which can be passive or active, on a substrate such as a silicon chip and various dimensions thereof referred to below. Such passive haircell sensors are described in references 1, 2, and 3 below, which are incorporated herein by reference. The passive haircell sensor is shown in FIGS. 6A, 6B, 11-13 and 16 as comprising a cylindrical, substantially rigid artificial cilium (12) made of SU-8 epoxy located at a distal end of a paddle-shaped silicon cantilever beam (10), which includes one or more doped silicon piezoresistive strain gages (piezoresistive elements) are located at the base of the cantilever. The output of the piezoresistive element is sent through a Wheatstone resistor bridge to a conventional signal processing device.

Such passive haircell sensors, as well as active haircell sensors described below, exhibit a number of important technical and operational advantages:
1) the sensor fabrication process is compatible with microelectronics processing, making low cost sensors possible by leveraging the microelectronics infrastructure;
2) the sensor performance is the highest in all existing flow-sensing devices, in terms of detection limit;
3) many sensors can be fabricated side by side to form an array.

### Structural Model of Passive Sensor

The passive AHC device shown schematically in FIGS. 1-2 consists of the artificial cilium located at the distal end of a paddle-shaped silicon cantilever. Doped silicon strain gauges are located at the base of the cantilever. The cilium is made of photodefinable SU-8 epoxy and is considered rigid. Lateral force along the on-axis (axis that is parallel with the cantilever longitudinal axis) acting on the cilium would create a bending moment (M), which is translated to the silicon beam through the stiff joint therebetween. The off-axis is considered perpendicular to the on-axis. The torque introduces a longitudinal strain and can be detected by piezoresistors at the base. The relation between the induced strain (ε) and the moment is given by:

$$ɛ = \frac{6 M}{{Ewt}^{2}} , \qquad ( 1 )$$

where E is the Young's modulus of silicon, w the cantilever width, and t the cantilever thickness.

When used as a flow sensor, flow passing through the cilium introduces a bending moment (M) due to frictional and pressure drag. The sensitivity analysis is presented in the next section.

The moment exerted on the cilium, M, is estimated using the local drag coefficient approach references [4, 5]. The cilia are cylindrical in shape and are modeled as right cylinders of uniform cross-section and finite length. The flow characteristic in this case is assumed to be nearly two dimensional. Applicant also assumes the case of steady-state flow for the analysis. Further, the direction of the flow is perpendicular to the longitudinal axis of the cilium.

The cylindrical cilium is divided into N segments with unit length Δh. Applicant assumes the linear density of local drag force, F_{D}_{_{—}}ᵢ; (i=1, 2, 3 . . . N), is constant along each segment. The magnitude of drag force (F_{D}) exerted on each segment of the cilium is estimated by

$${F}_{D\_i} \approx \frac{1}{2} {C}_{D} ( {u}_{i} ) ρ {du}_{i}^{2} Δ h , \qquad ( 2 )$$

where uᵢ is the local flow velocity at the i^{th} segment of the cilium, C_{D}(uᵢ) the local drag coefficient, ρ the fluid density and d the diameter of the cilium.

The procedure for estimating C_{D} is discussed here. The local drag coefficient C_{D}(uᵢ) is dependant on the local Reynolds number. For Re(uᵢ)<10, the magnitude of C_{D}(uᵢ) is determined by logarithmically interpolating the experimental drag coefficient versus Reynolds number data [5], according to

ln C_{D}(uᵢ)≈−0.67 ln Re(uᵢ)+2.51 (3)

Otherwise, the drag coefficient is determined by graphically interpolating the experimental data in reference [6].

The Reynolds number is dependent on the local flow velocity, uᵢ. The local Reynolds number is related to the local flow velocity by

$$Re ( {u}_{i} ) = \frac{ρ {u}_{i} d}{μ} . \qquad ( 4 )$$

In order to estimate the magnitude of uᵢ, the flow velocity profile along the length of the cilium shank is determined first. In micro scale, the formation of boundary layer has significant effect on the flow velocity profile along the cilium. Depending on the applications, the haircell elements are often entirely immersed in the boundary layer, although occasionally the immersion may be partial. The boundary layer thickness (δ) is calculated based on flow velocity and distance from the leading edge of the aerodynamic structure, on which the AHC sensors are mounted, according to

$$δ \approx \frac{5.0}{\sqrt{U ρ / μ x}} , \qquad ( 5 )$$

where ρ is the viscosity, x the distance from the leading edge and U the steady state mean stream inflow velocity.

If a section of the cilium is completely immersed in the boundary layer, the local velocity is determined by the velocity profile along the cilium, reference [6]. If a section lies outside of the boundary layer, the local flow velocity, uᵢ, is taken as the mean stream velocity, U.

Integrating local drag force over the length of the cilium, h, will give us an estimate of moment acting at the base of the cilium. This is done by numerical integration over the N segments of the cilium,

$$M = {\sum }_{i = 1}^{N} \frac{1}{2} {C}_{D} ( {u}_{i} ) ρ {du}_{i}^{2} Δ {h}^{2} . \qquad ( 6 )$$

Here, M is also equal to the moment loaded on the distal end of the cantilever.

These equations only serve as an estimate of the moment loading of the cantilever. One source of error in the analysis comes from the drag coefficients. Cylinders of finite length have smaller drag coefficient comparing to cylinders of infinite length, reference [7]. Further, applicant has assumed the simplest case where the cilium is fixed on the substrate in the flow. In fact, the cantilevers may be deflected slightly, causing the effective height of the cilium to change at high flow velocity.

The ACH sensor devices are fabricated on SOI wafers with a 2-μm-thick epitaxial silicon layer on top, 2-μm-thick oxide, and 300-μm-thick handle wafer. SU-8 epoxy is chosen for its ability to form rigid high aspect ratio structures. The piezoresistive strain gauges are achieved by ion implantation. The ion implantation is performed on very lightly doped, <100>-oriented, n-type device layer of the SOI wafer. The wafer is selectively doped to p-type with boron to take advantage of the higher gauge factor of p-type silicon, reference [8]. To optimize the performance of the stain gauge, applicant chooses the ion implantation parameters so that the doping depth is approximately ⅓ of the total beam thickness and the doping concentration is on the order of 1×10²⁰ cm⁻³, reference [9]. The ion implantation was performed at 60 KeV energy for a dose of 2×10¹⁵ cm⁻².

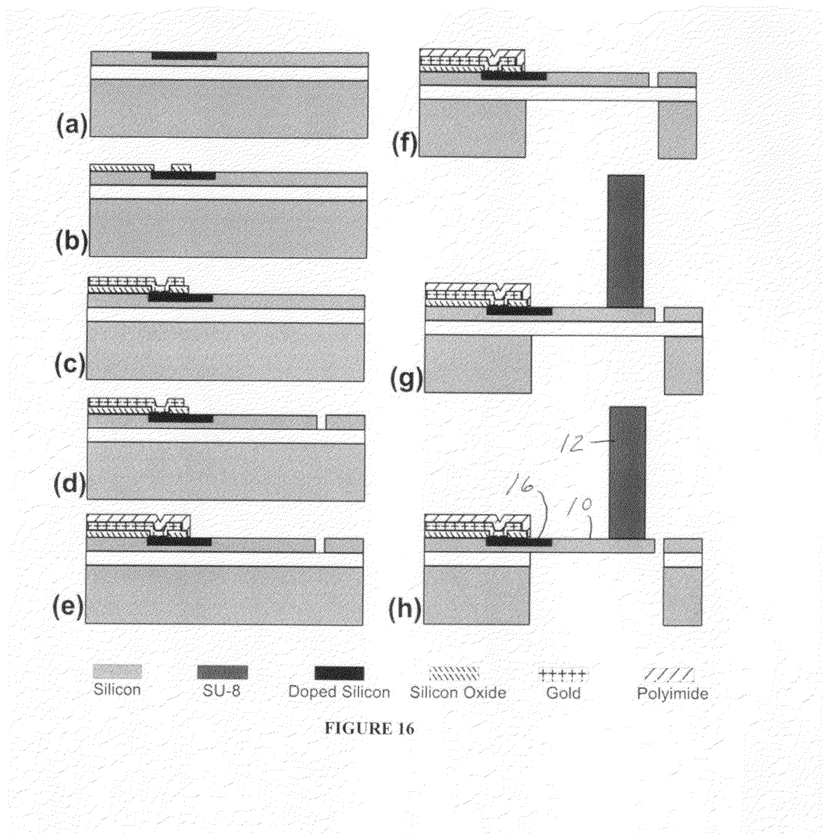

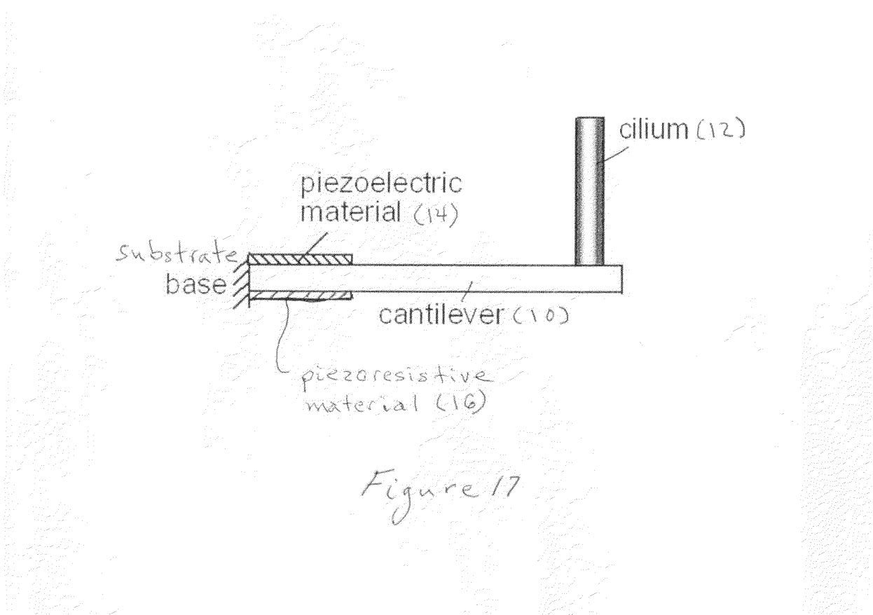

The SOI wafer is first oxidized and patterned for ion implantation [FIG. 16(a). After the ion implantation step, applicant performs a drive-in at 1100° C. for 13 min in oxygen and water vapor mixture. At the same time a thin layer of oxide is formed to serve as the insulation layer. Contact windows are opened to the doped silicon [FIG. 16(b)]. Electrical connection is formed, consisting of a 5000-A-thick gold layer with a 500-A-thick titanium film serving as the interfacial layer [FIG. 16(c)]. Applicant uses lift-off process for this metallization step. A quick (<5 s) native oxide removal step is performed before metallization using BOE (buffered oxide etch).

The paddle-like cantilevers are then defined by front side DRIE (see FIG. 16(d)]. A 5-μm-thick polyimide protection layer is applied to protect the metal leads from the later on BOE (FIG. 16 (e)] etching. Backside etching is performed using DRIE to create the cavities underneath the cantilevers [FIG. 16(f)]. The DRIE process stops at the buried oxide layer due to slow etch rate on the oxide. A single layer of SU-8 2075 (MicroChem Inc) is then spun on. At 500 rpm and 30 seconds, the achieved thickness is 550 μm (FIG. 16(g)]. 700 μm thickness can be achieved by spinning the sample at 400 rpm for 25 seconds.

For pre-exposure bake, the samples are ramped up to 105° C. at 150° C./hr ramp rate and soaked at 105° C. After a total bake time of 13 hours the samples are then ambient cooled to room temperature. The photolithography is done using a Karl Suss contact aligner at 365 nm. A high-wavelength-pass optical filter with cutoff wavelength of 300 nm is used during exposure to eliminate the “T-topping” effect of the SU-8 structures, which has been observed by others as well, reference [10]. The exposure dose is 3000 mJ/cm². For a light intensity of 10 mW/cm², the exposure time is 5 min. For post-exposure bake, the samples are again ramped up to 105° C. at 150° C./hr ramp rate and kept at 105° C. for half an hour. The samples are then ramped down to room temperature at a controlled rate of 15° C./hr.

After the post-exposure bake, the wafer is to be diced up using a dicing saw. The wafer is first flip-bonded to the dicing saw adhesive tape with the backside of the SOI wafer facing up. It is then diced up with the dicing depth carefully calibrated so that the SOI wafer is diced through but the SU-8 thick film is still holding up in one piece. No cracking or debonding from the substrate is observed in the SU-8 thick film during dicing. Subsequently, the pre-exposed SU-8 epoxy is developed. The development is performed using designated SU-8 developer with IPA as the end point indicator. Upon the development of SU-8 thick film, the dies (typically 3×5 mm in size in the current run) are mechanically released from each other into individual sensor units by breaking along the diced groves. Developing the SU-8 after the physical dicing is critical to ensure 100% process yield. If the development is done prior to the dicing, the cooling fluid jet may damage the cilia and/or the paddle.

The sensor devices are released in BOE to free the cilium-on-cantilever structures [FIG. 16(h)]. The successful release of buried oxide membrane is highly dependent on the cleanness of oxide surface. A 10-min-long oxygen plasma cleaning step performed on both the front side and the backside of the samples at 300 W (power) and 300 mTorr (pressure) setting is found to be very efficient in cleaning up the residual. No visible damage to the SU-8 cilia is observed during the oxygen plasma cleaning.

The SU-8 properties are very sensitive to processing parameters and ambient environment, reference [11]; hence calibration is needed for different lab settings. Once the processing recipe is established, it is very repeatable and able to achieve high device yield.

Finally, the entire sensor can be chemically treated or encapsulated to prevent electric leakage, or adverse chemical reactions. One possible option is to encapsulate the structure with a conformal coverage of Parylene thin film.

The cilia are made in a monolithically integrated process, eliminating the needs of low-yield and low-efficiency manually assembly. The signal processing electronics also can be integrated with the sensor monolithically wherein the pre-fabricated electronics reside in the epitaxial silicon layer on the SOI wafer.

As mentioned above, practice of the present invention envisions an array of a plurality of passive and/or active artificial sensors wherein the sensors are systematically configured and arranged relative to one another in the array to achieve both large dynamic range and low detection limit. The passive haircell sensors are described in detail above and in references 1, 2, and 3.

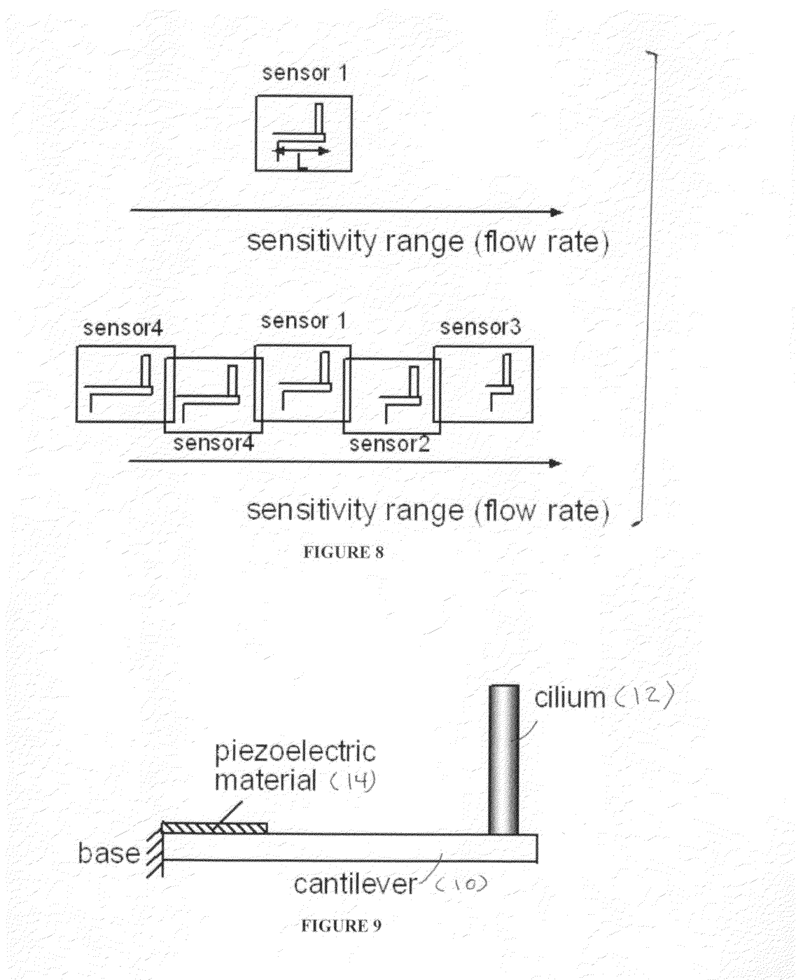

The active sensors can be provided pursuant to another embodiment of the invention as an active haircell sensor. In particular, referring to FIG. 9, the individual active haircell sensor comprises a horizontal cantilever (10), an artificial cilium (12) located at the distal end of the cantilever, and an active piezoelectric element (14) on the cantilever and/or the cilium wherein the piezoelectric element (14) can cause displacement upon receiving an electrical input or can generate electrical signal or charge accumulation upon mechanical deformation of the sensor. The piezoelectric material can be selected from many choices, including PZT, ZnO, PVDF, and other materials of strong or week piezoelectric coupling. The piezoelectric element can be located on the cantilever or the artificial cilium, or on any part of the haircell sensor structure as long as favorable electrical-mechanical conversion can be achieved and the fabrication process is feasible. The active haircell sensor can be microfabricated using MEMS processing similar to that shown in FIG. 16a-16h.

The piezoelectric element of the active haircell sensor can function as an active actuator and/or active energy harvesting element in flow sensing applications. For example, the piezoelectric element can convert electric potential (or field) to mechanical stress and displacement to oscillate or vibrate in a manner to interact with the fluid environment. Conversely, the piezoelectric element can turn mechanical stress and strain into charge accumulation and electric potential for energy harvesting. As such, the active haircell sensor can perform a number of unique functions, including:
5) producing displacement and vibration upon applying an electric bias;
6) generating a signal proportional to the external stimuli input;
7) producing charge accumulation and energy accumulation (harvesting) upon mechanical input;
8) it is also possible to oscillate the haircell at a certain frequency, and then use the same piezoelectric element or other means to monitor the magnitude of the response. Since the response is a function of the viscosity of the fluid surrounding the hair, the viscosity of the fluid can be measured.

When functioning as an active energy harvesting element, the signal output of the piezoelectric element can be rectified to a DC signal and sent to a storage capacitor of a controller for later use of the stored energy. When functioning as an active actuator to oscillate or vibrate in a fluid environment, the input of the piezoelectric element can be connected to a suitable computer controlled oscillator to provide DC oscillating voltage signals to the piezoelectric element.

In still another embodiment of the invention, the individual haircell sensor for use in the array can include both a active piezoelectric element (14) and a passive position-sensing piezoresistive element (16) as shown in FIG. 17.

A one- or two-dimensional array of the passive and/or active haircell sensors typically is provided wherein one or more haircell parameters systematically change from one sensor to the next in the array to achieve both large dynamic range and low detection limit. The haircell parameters of interest can include the height (h) of the artificial cilium, the diameter (d) of the artificial cilium, the cantilever length (l), the cantilever width (w), the cantilever thickness (t) and/or relative cantilever orientations to this end.

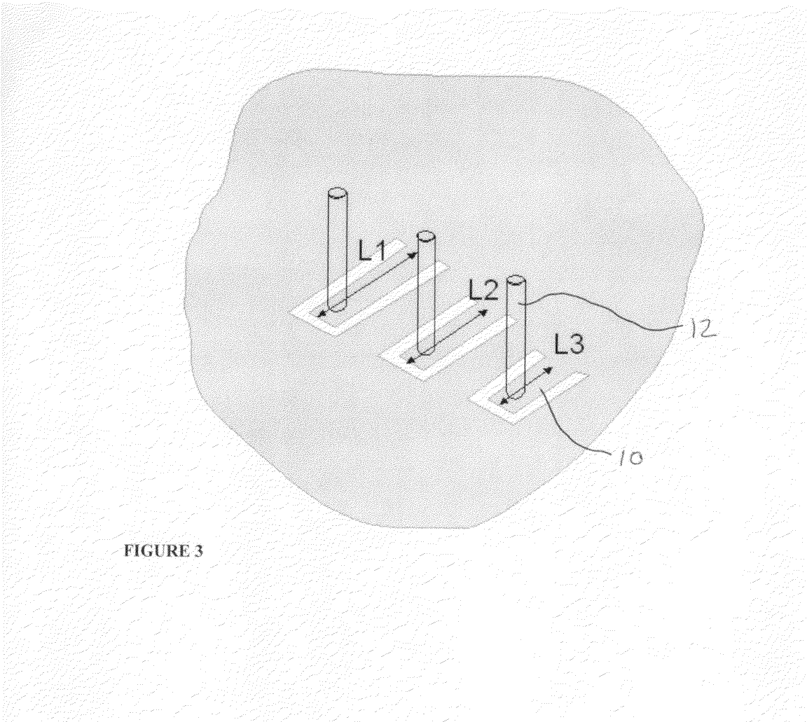

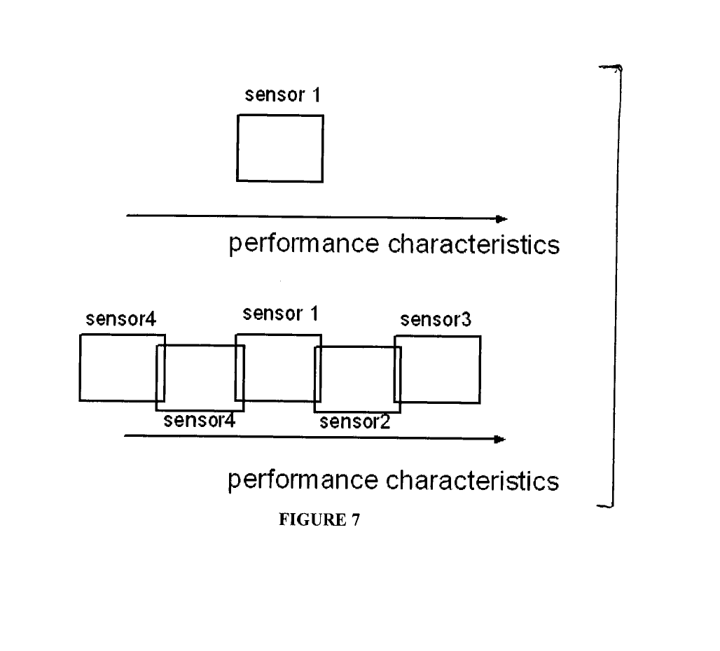

Referring to FIG. 3, a representative one-dimensional array of three haircell sensors where the length of the cantilevers L1, L2, and L3 is varied in preselected increments from one sensor to the next in the array is shown. This array having haircell sensors with varying cantilever lengths from one sensor to the next pursuant to the invention can cover a much broader range of desired performance characteristics (e.g. flow rate, frequency response, etc.) than a single haricell sensor as explained below in connection with FIGS. 7 and 8.

FIG. 4 illustrates a representative one-dimensional array of three haircell sensors where the height h1, h2, h3 is varied in preselected increments form one sensor to the next in the array. This array having haircell sensors with varying cilium heights from one sensor to the next pursuant to the invention can cover a much broader range of desired performance characteristics (e.g. flow rate, frequency response, etc.) than a single haricell sensor as explained below in connection with FIGS. 7 and 8.

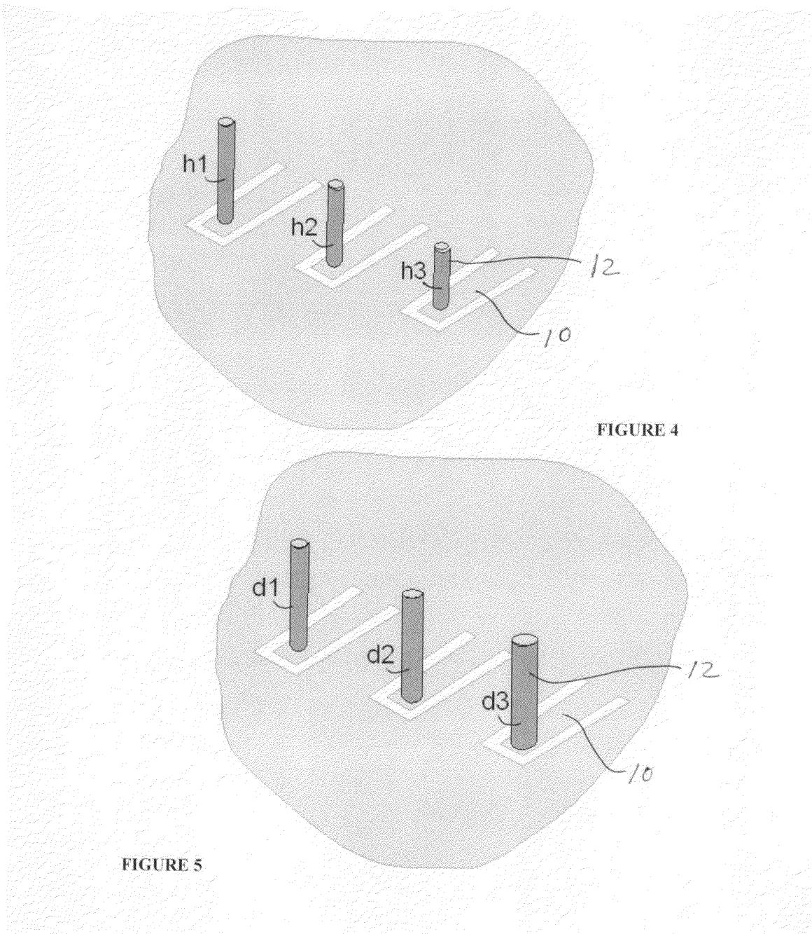

FIG. 5 illustrates a representative one-dimensional array of three haircell sensors where the diameter d1, d2, d3 of the artificial ciliums is varied in preselected increments from one sensor to the next in the array. This array having haircell sensors with varying cilium diameters from one sensor to the next pursuant to the invention can cover a much broader range of desired performance characteristics (e.g. flow rate, frequency response, etc.) than a single haricell sensor as explained below in connection with FIGS. 7 and 8.

FIG. 6A is a photomicrograph of an array of three haircell sensors where the cantilever length is varied in increments from one sensor to the next and the longitudinal axes of the cantilevers are parallel.

FIG. 6B is a photomicrograph of an array of three haircell sensors where the cantilever lengths are the same but the cantilever orientations are different (i.e. the longitudinal axes of the cantilevers are at an angle to one another; namely, perpendicular to one another) also to cover a broader range of desired performance characteristics (e.g. flow rate, frequency response, etc.) than a single haricell sensor.

FIGS. 7 and 8 are schematic diagram showing that arrayed sensors with varying parameters such as l, w, t, h, d, can cover a much broader range of desired performance characteristics (e.g. flow rate, frequency response, etc.) than a single sensor. For example, FIG. 8 shows that arrayed haircell sensors with varying cantilever lengths from one sensor to the next pursuant to the invention can cover a much broader range of desired performance characteristics (e.g. flow rate, frequency response, etc.) than a single haircell sensor with cantilever length L. In the array, the cantilever length decreases from sensor to sensor 4, from sensor 4 to sensor 1, from sensor 1 to sensor 2, and sensor 2 to sensor 3 to this end.

Practice of a further embodiment of the invention provides a multi-modal flow sensor that comprises one or more the above-described passive and/or active haircell sensors, one or more pressure sensors, one or more temperature sensors, etc. For example, using the same MEMS microfabrication process as used to fabricate the haircell sensor, it is possible to fabricate a sensor chip that also contains one or more diaphragm pressure sensors, hot film anemometers, hot wire anemometers, thermal-transfer based flow shear stress sensors, temperature sensors, and time-of-flight flow velocity sensors.

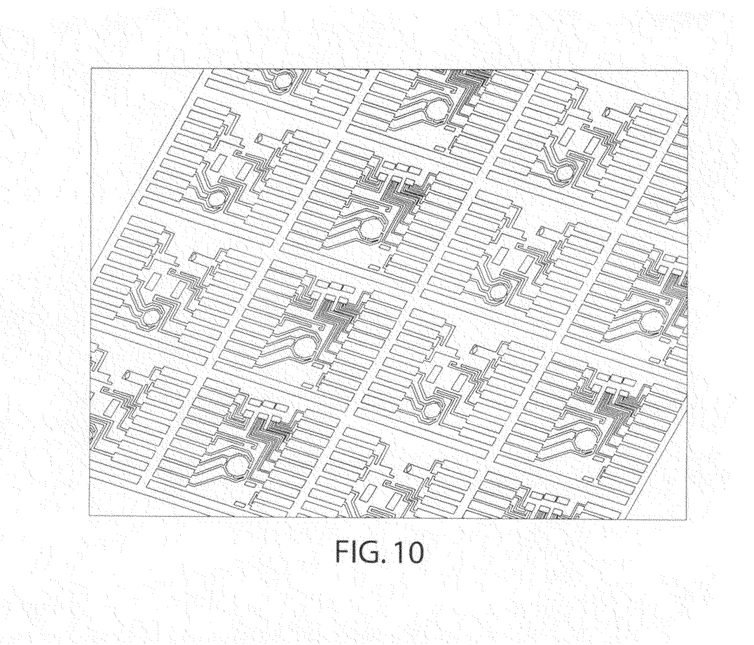

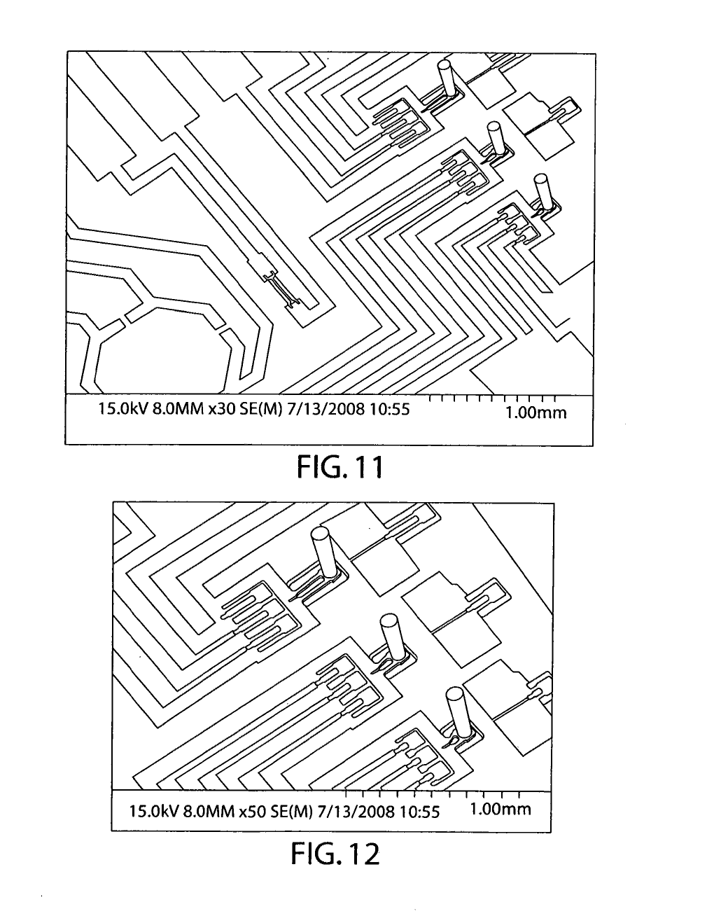

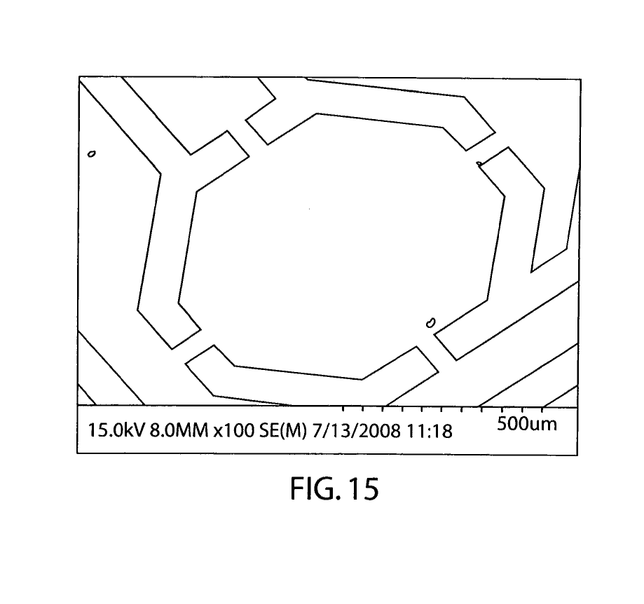

Referring to FIG. 10, a photomicrograph shows a representative multi-modal sensor silicon chip containing multiple sensor sets with each sensor set having three passive haircell flow sensor (shown in detail in FIGS. 11-12), a pressure sensor (FIG. 15), and a thermal sensor (FIG. 14).

FIG. 11 is a scanning electron micrograph (SEM) of a section of the sensor chip of FIG. 10 showing three haircell sensors with varying cantilever lengths from one haircell sensor to the next, a thermal sensor, and a pressure sensor. FIG. 12 is an enlarged view of the three haircell sensors of FIG. 11 better showing the decreasing cantilever lengths from one sensor to the next in the SEM.

FIG. 14 is a SEM of the thermal isolated sensor on the sensor chip of FIG. 11 wherein the sensor can measure temperature of the fluid or the thermal shear stress of the fluid boundary layer. FIG. 15 is a SEM of the membrane pressure sensor on the sensor chip of FIG. 11.

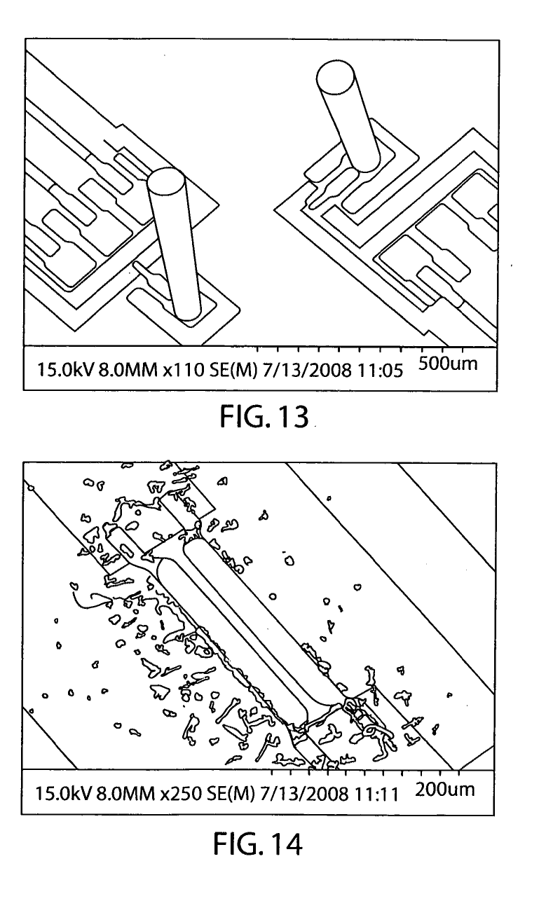

FIG. 13 is a SEM of two neighboring haircell sensors that are positioned at an angle to one another; e.g. the longitudinal axes of the cantilevers are perpendicular to one another.

Such multi-modal flow sensor chip as shown in FIG. 10 can be employed in a fluid field to present a more comprehensive view (measured data) of the flow field of interest.

The invention envisions in the practice of the embodiments described above treatment of haircell sensor in a manner to chemically functionalize parts of the haircell sensor. For purposes of illustration and not limitation, the artificial cilium can be treated with a chemical functional binding material such that a species in the fluid will bind with the chemically functionalized cilium and change the sensor's mass upon such binding. As a result, the sensor will be made capable of chemical and biological sensing.

Although the invention has been described in detail in connection with certain embodiments thereof, those skilled in the art will appreciate that changes and modification can be made therein within the scope of the invention as set forth in the appended claims.

### REFERENCES WHICH ARE INCORPORATED HEREIN BY REFERENCE

1. Chen, N., et al., Design and Characterization of Artificial Haircell Sensor for Flow Sensing With Ultrahigh Velocity and Angular Sensitivity. IEEE/ASME Journal of Microelectromechanical Systems (JMEMS), 2007. 16(5): p. 999-1014.
2. Liu, C., et al. Polymer Micro and Nano Scale Fabrication Technology Development for Bioinspired Sensing. in IEEE International Conference on Nano/Micro Engineered and Molecular Systems. 2006. Zhuhai, China.
3. Liu, C., Foundations of MEMS. Illinois ECE Series. 2005: Prentice-Hall.
4. Fan, Z., et al., Design and Fabrication of Artificial Lateral-Line Flow Sensors. Journal of Micromechanics and Microengineering, 2002. 12(5): p. 655-661.
5. Ben T. Dickinson, B. A. B., John R. Singler, Modeling of Bioinspired Sensors for Flow Separation Detection for Micro Air Vehicles. American Institute of Aeronautics and Astronautics.
6. Fox, R. W. and A. T. McDonald, Introduction to Fluid Mechanics. 1992, New York: Wiley.
7. Prandtl, L., Essentials of Fliud Dynamics. 1952, New York: Hafner Publishing Company.
8. Liu, C., Fundations of MEMS. 2005: Prentice Hall.
9. Harley, J. A. and T. W. Kenny, 1/F noise considerations for the design and process optimization of piezoresistive cantilevers. Journal of Microelectromechanical Systems, 2000. 9(2): p. 226-235.
10. S. J. Lee, W. S., P. Maciel, S. W. Cha. Top-edge Profile Control for SU-8 Structural Photoresist. in University/Government/Industry Microelectronics Symposium—Proceedings of the 15th Biennial. 2003.
11. H. Lorenz, M. D., N. Fahrni, N. LaBianca, P. Renaud, P. Vettiger, SU-8: A Low-cost Negative Resist for MEMS. Journal of Micromechanics and Microengineering, 1997. 7(3): p. 121-124.

1. A device comprising an array of sensors,
wherein each sensor comprises a cantilever, an artificial cilium on the cantilever, and a sensing element and wherein individual sensors within the array have different cantilever and/or cilium parameters and therefore different flow sensitivity range and frequency response range, said sensors being so systematically arranged in the array relative to adjacent sensors that performance of the individual sensors sum up to cover a larger range of sensing.

2. The device of claim 1 wherein the sensors are arranged in a one-dimensional array or a two dimensional array.

3. The device of claim 1 where the sensing element comprises a piezoresistive element or a strain gage.

4. The device of claim 1 wherein each sensor comprises a horizontal cantilever with a length of “l”, a width of “w”, and a thickness of “t”; and an artificial cilium located at the distal end of the cantilever with a cilium height of “h” and a cilium diameter of “d”.

5. The device of claim 4 wherein “1” changes systematically from one sensor to another in the array.

6. The device of claim 4 wherein “d” changes systematically from one sensor to another in the array.

7. The device of claim 4 wherein “h” changes systematically from one sensor to another in the array.

8. The device of claim 4 wherein “d” changes systematically from one sensor to another in the array.

9. The device of claim 4 wherein “t” changes systematically from one sensor to another in the array.

10. The device of claim 4 wherein more than one of h, d, l, w, t change systematically from one sensor to another in the array.

11. The device of claim 1 wherein one or more of the sensors also includes a piezoelectric element wherein the piezoelectric element can cause displacement upon receiving an electrical input or can generate electrical signal or charge accumulation upon mechanical deformation of the sensor.

12. The device of claim 1 that further includes at least one of a pressure sensor, flow shear stress sensor, heated element, and temperature sensor to achieve a multimodal flow sensing device.

13. An active sensor, comprising a cantilever, an artificial cilium on the cantilever, and a piezoelectric element wherein the piezoelectric element can cause displacement upon receiving an electrical input or can generate electrical signal or charge accumulation upon mechanical deformation of the sensor.

14. The sensor of claim 13 that further includes a piezoresistive element.

15. The sensor of claim 13 that further includes at least one of a pressure sensor, flow shear stress sensor, heated element, and temperature sensor to achieve a multimodal flow sensing device.

16. The sensor of claim 13 that is capable of measuring viscosity of a fluid.

17. A sensor array comprising one or more sensors of claim 1 wherein the array is capable of monitoring the flow velocity, flow viscosity, flow temperature, flow pressure, and flow shear stress.

18. A sensor array that comprises one or more sensors of claim 13 that is capable of monitoring the flow velocity, flow viscosity, flow temperature, flow pressure, and flow shear stress.

19. A fluid sensor, comprising a cantilever and an artificial cilium on the cantilever wherein the cantilever and/or cilium is functionalized with a binding material to bind to a species in a fluid.
